(19) United States
(12) Patent Application Publication
(10) Pub. No.: US 2007/0291585 A1
(43) Pub. Date: Dec. 20, 2007

(54) LIQUID CONTAINER WITH STIR MECHANISM

(76) Inventor: Dave Sivers, Keizer, OR (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/751,397

(22) Filed: May 21, 2007

Related U.S. Application Data
(60) Provisional application No. 60/804,758, filed on Jun. 14, 2006.

(51) Int. Cl. B01F 7/00

(52) U.S. Cl. 366/253; 366/242; 366/247

(57) ABSTRACT

A pitcher assembly having a pitcher body is provided. The pitcher body has a handle and lid assembly. The lid assembly may comprise a lid body and a mixing rod extending downward from the lid. The mixing rod may include one or more mixing leaves. The mixing rod may be adapted to rotate to stir the contents of the pitcher. The actuation of the mixing rod may be via a plunger assembly that operates a one-way clutch mechanism, such that operating the plunger assembly causes the mixing rod to rotate in the pitcher.

### CROSS-REFERENCE TO RELATED APPLICATIONS

This application claims the benefit and priority of U.S. Provisional Patent Application No. 60/804,758, filed Jun. 14, 2006.

### TECHNICAL FIELD

The present invention relates generally to liquid containers. More specifically, the present invention relates to liquid containers, such as pitchers, having a lid assembly with an onboard stir mechanism.

### BACKGROUND OF THE INVENTION

Many different types of liquid containers are known in the art. Pitchers, ewers, and the like typically comprise a body with an open top and a handle. Additionally, containers may have a lid that is complementary to the open top, such that the lid can be engaged with the pitcher to at least somewhat seal the contents from the ambient environment.

One disadvantage of prior art pitchers is that, when the user prepares a drink by mixing two or more ingredients together, he or she typically must use a separate implement such as a spoon to agitate or stir the ingredients. Additionally, as the lid is not engaged when the user stirs the contents, the contents have a tendency to spill out of the vessel.

### BRIEF DESCRIPTION OF THE DRAWINGS

FIG. 1 is a perspective view of a pitcher assembly according to an embodiment of the present invention.

FIG. 2 is an exploded view of the pitcher assembly of FIG. 1

FIG. 3 is a perspective view of a plunger.

FIG. 4 is a perspective view of the lid assembly.

FIG. 5 is a top perspective view of the lid assembly, shown with plunger and spring removed.

FIG. 6 is a perspective view of a stir rod.

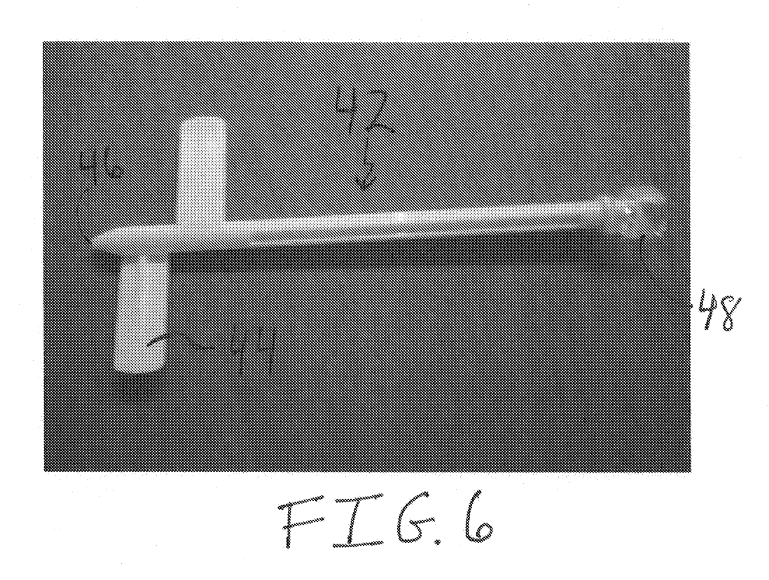

FIG. 7 is a bottom view of a lid assembly, shown with stir rod removed.

### BRIEF SUMMARY OF THE INVENTION

In one embodiment, a pitcher assembly comprises a pitcher body, the pitcher body having a handle and lid assembly. The lid assembly may comprise a lid body and a mixing rod extending downward from the lid. The mixing rod may include one or more mixing leaves. The mixing rod may be adapted to rotate to stir the contents of the pitcher. The actuation of the mixing rod may be via a plunger assembly that operates a one-way clutch mechanism, such that operating the plunger assembly causes the mixing rod to rotate in the pitcher.

### DETAILED DESCRIPTION OF AN EMBODIMENT OF THE INVENTION

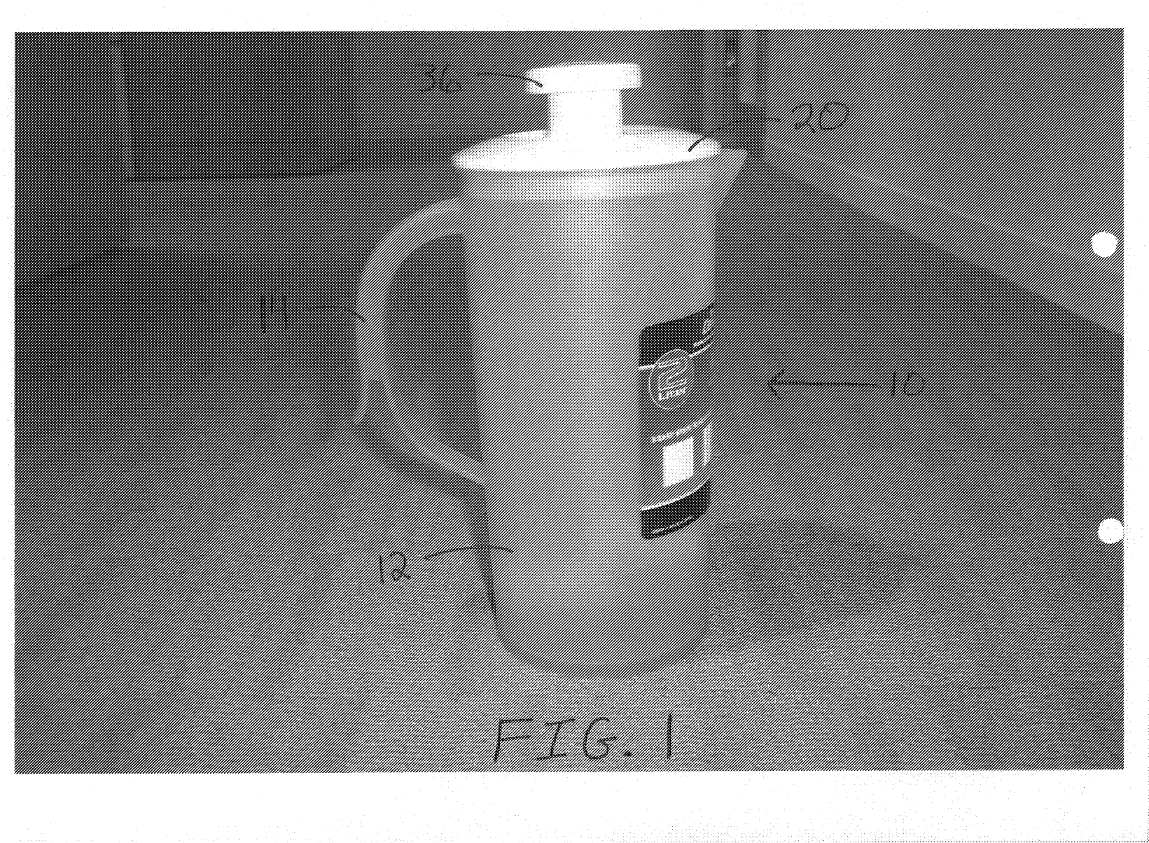

A container for holding liquid, or pitcher assembly, generally identified by reference numeral 10, is illustrated in FIG. 1. Pitcher assembly 10 may comprise a housing or a pitcher body 12 that may optionally include one or more handles 14. The pitcher body 12 may include a spout portion formed near a top edge of the pitcher body (not numbered) to facilitate easy poring of the liquid. The pitcher assembly 10 may also comprise a lid 20 having an outer surface 23 opposed to an inner surface 25 for covering an opening 21 formed along a top edge of the pitcher body 12. Lid 20 may additionally comprise an elongated downwardly-extending member (not numbered) that, when aligned with the spout portion, seals the contents contained within the pitcher body 12. If the user wishes to pour the contents with the lid 20 installed the lid 20 may be rotated such that the elongated downwardly-extending member is not engaged with the spout portion.

It is contemplated that the contents in the pitcher assembly are stirred or agitated upon actuation of an engagement mechanism, such as a plunger 36, which is connected with a mixing rod 42 which extends inside the pitcher body 12, while the lid 20 is engaged with and covers the pitcher body 12. Any mechanism known in the art for accomplishing this task is contemplated for use in the present invention. In one embodiment, the engagement mechanism includes a button (not shown) connected with a rotational member, such as an electric motor (not shown) or a clutch. The rotational member is then mechanically connected with the mixing rod 42, and upon pressing the button, the rotational member rotates to turn the mixing rod 42. An exemplary embodiment of a mechanism is hereinafter described.

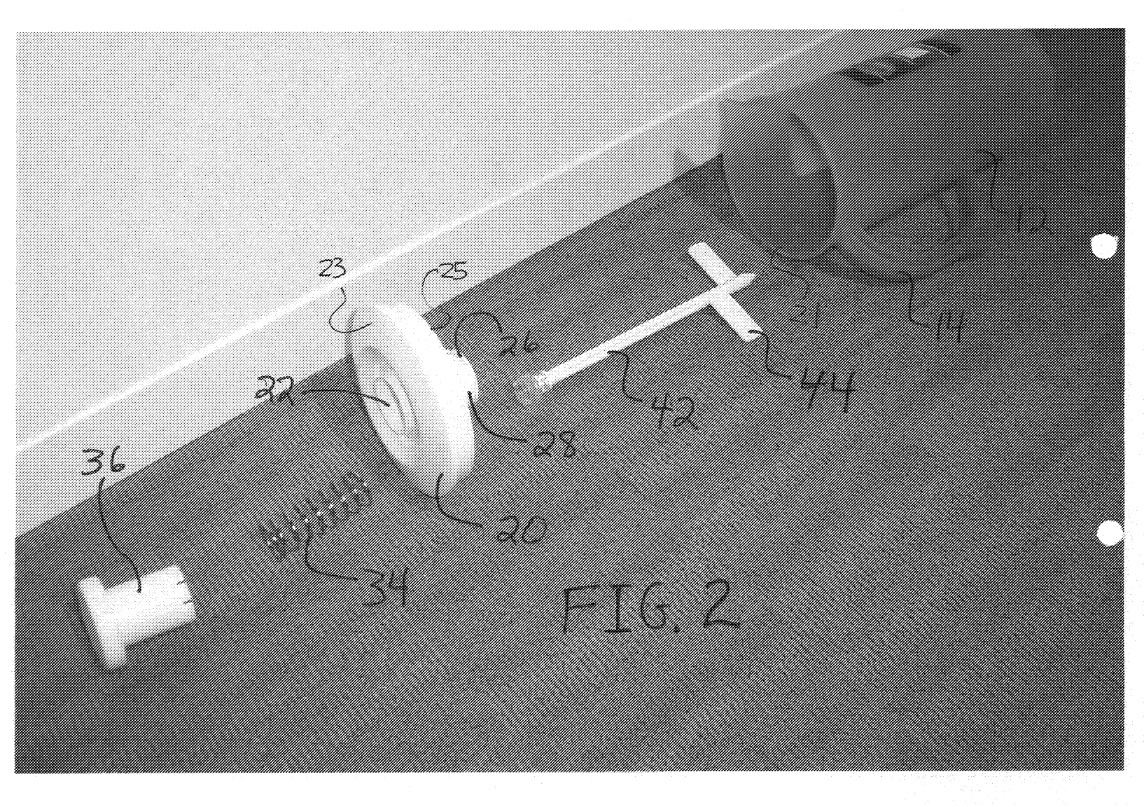

Referring now to FIG. 2, an exploded view of pitcher assembly 10 is illustrated. Lid 20 may include a recess 22 that receives a biasing member, such as spring 34, and plunger 36. Spring 34 may abut against a shoulder or other surface within recess 22. In an embodiment, spring 34 may abut against clutch housing 28 on one end and against an interior surface of the plunger 36 on the other end. As such, the spring 34 urges plunger 36 back into its resting position after the plunger is depressed.

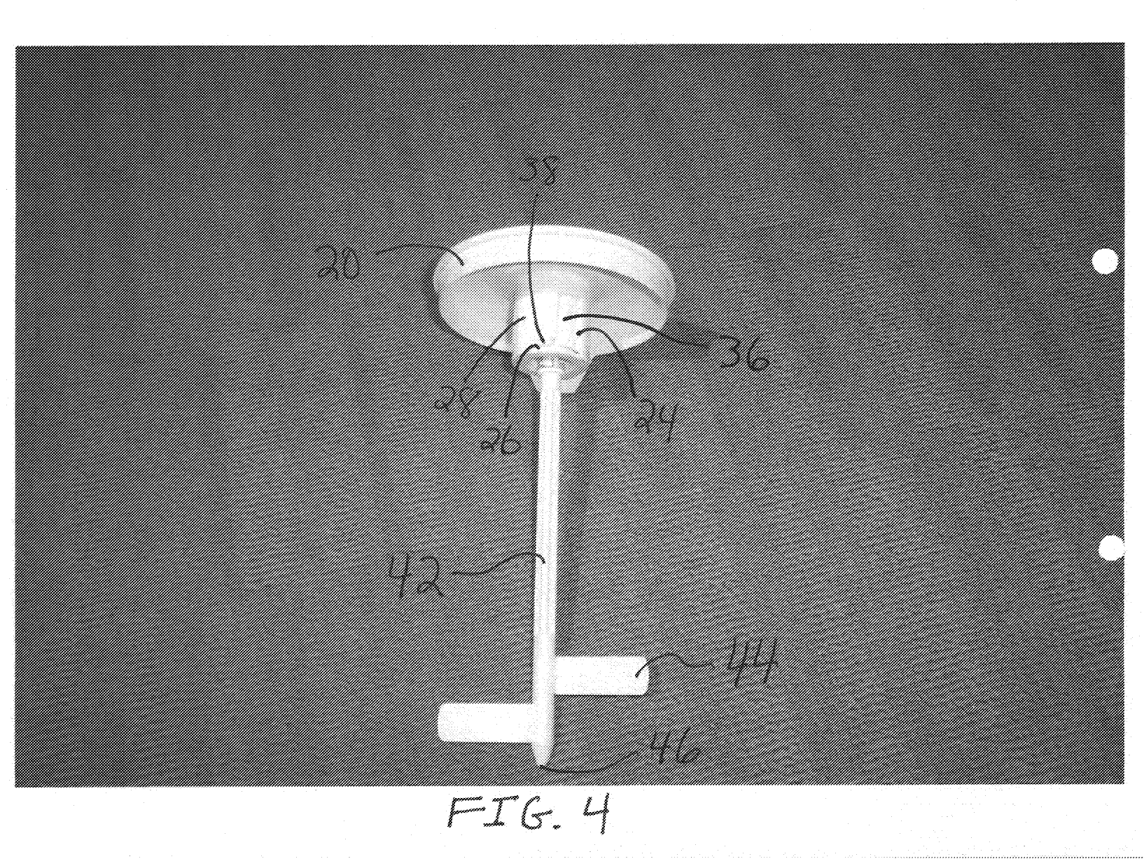

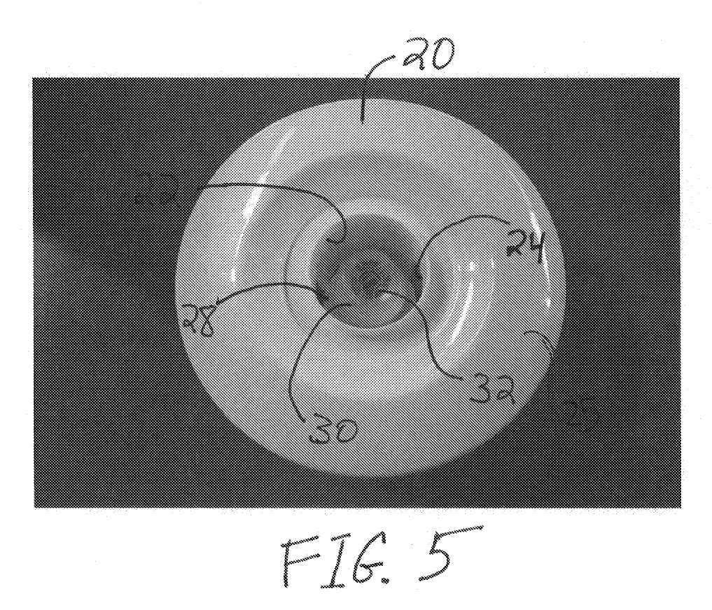

Recess 22 may include axial apertures 24, as best seen in FIGS. 4 and 5. Axial apertures or grooves 24 receive projections 38 on plunger 36, such that plunger 36 may only be installed properly in one of two positions that are 180 degrees from each other. Projections 38 may bias inwardly upon initial insertion into recess 22 and subsequently snap into engagement with apertures 24, such that the plunger cannot be withdrawn from the recess 22 during normal use. As best illustrated in FIG. 4, recess 22 may optionally include radially-extending apertures 26. Radially-extending apertures 26 receive projections 38 upon full depression of the plunger and rotation of the plunger. When projections 38 are engaged with radially-extending apertures 26, the plunger is fixed in a depressed configuration. This optional locking feature may be useful to aid in reducing the effective height of pitcher assembly 10 so that it may fit in a storage area such as a refrigerator more easily.

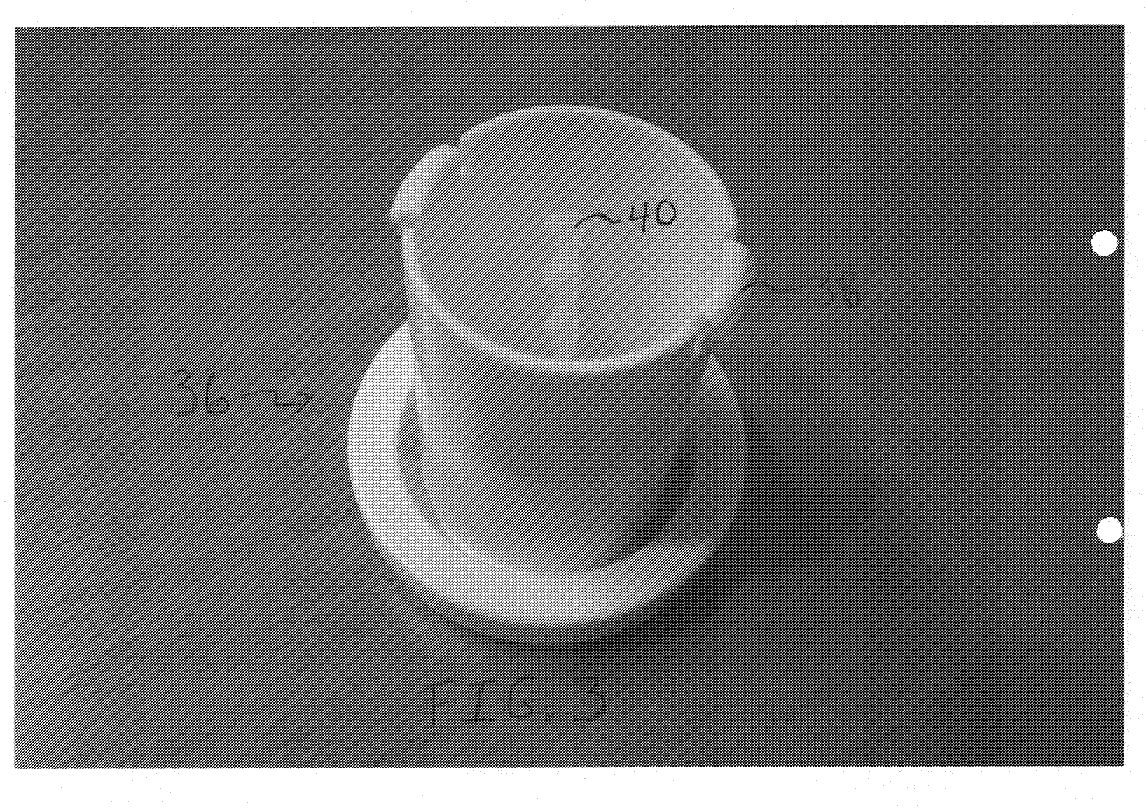

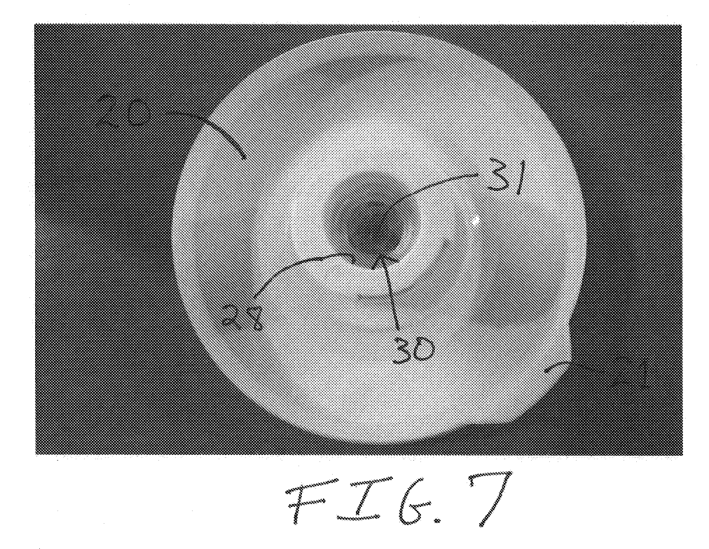

As illustrated in FIG. 3, a projecting member or threaded rod 40 may be housed within the interior of plunger 36. Threaded rod 40 may be fixed such that it does not rotate, and may extend generally axially relative to the plunger 36. Threaded rod 40 may be received within slot opening 31 in clutch body 30 (see FIG. 7). Clutch body 30 or at least a portion of clutch body 30 may be rotatably engaged with clutch housing 28. Clutch housing 28 may be attached to or continuous with the lower portion of recess 22, such that clutch housing extends upward into recess 22. Slot opening 31 may be operably connected to or integral with one or more pawl or sprag members 32, such that rotation of the slot, and thus pawls 32, in one direction causes all or at least an output portion of clutch body 30 to rotate, while rotation of the pawls 32 in the opposite of the direction does not cause the clutch body 30 to rotate. In one embodiment of the present invention, the slot opening 31 is formed directly in the center of the sprag member body.

The output end of the clutch body 30 may be connected to mixing rod 42 via a connector 48. Any type of connecting member is contemplated, such as a bayonet connection. Alternatively, mixing rod 42 and the clutch body may be integral or monolithic. Mixing rod 42 may have one or more mixing leaves 44 that agitate the liquid as the mixing rod 42 is rotated. Any number, arrangement, and location of mixing leaves 44 is contemplated for use in the present invention. Mixing rod 42 may optionally comprise a lower apex 46. Lower apex 46 may cooperate with a depression or recess in the bottom of pitcher body 12, providing a point of rotation.

In operation of the exemplary embodiment, the user may pour a liquid and any number of dry or wet ingredients into the pitcher body 12. Next, the user may install the lid body 20 onto pitcher body 12. Lid body 20 may have spring 34 and plunger 36 engaged in an upper facing surface, and mixing rod 42 engaged on a lower facing surface. As the user depresses the plunger 36, threaded rod 40 engages the slot in the clutch body 30 or sprag member, which may cause the sprag member to rotate in one direction. As the sprag member rotates, the sprags engage with a cam, shoulder or similar portion in the clutch body 30, which therefore causes the clutch body 30 to rotate within clutch housing 28. As the mixing rod 42 may be operably attached to the clutch body 30, the mixing rod 42 may rotate as well.

When the plunger is released, the spring 34 urges plunger 36 back to its original position. The threaded rod 40 may cause rotation of the slot and thus sprag members 32 in the opposite direction. If the clutch is a one-way clutch, the opposite rotation of the sprag members would not cause the clutch body 30 and mixing rod 42 to rotate in the opposite direction. After the plunger 36 has returned to its original resting position, the process can be repeated as many times as the user chooses. One the user has finished stirring the contents, he or she may choose to depress the plunger 36 and rotate it to engage plunger shoulders 38 with radial locking groove 26.

As will be appreciated by those of skill in this art, the preceding examples are provided, not to limit or define the scope of the present invention, but to illustrate the nature of the present invention and possible uses for the teachings of the present invention. These examples may be modified in many different ways while still obtaining the benefits of the teachings of the present invention. While the invention has been described and illustrated, this description is by way of example only. Additional advantages will occur readily to those skilled in the art, who may make numerous changes without departing from the true spirit and scope of the invention. Therefore, the invention is not limited to the specific details, representative machines, and illustrated examples in this description. Accordingly, the scope of this invention is to be limited only as necessitated by the accompanying claims. Various features and advantages of the invention are set forth in the following claims.

What is claimed is:

1. A pitcher assembly comprising:
a pitcher body; and
a lid assembly mounted on the pitcher body, the lid assembly having a lid with an outer surface opposed to an inner surface, a plunger movably connected with and extending from the outer surface, and a mixing rod movably connected with the plunger, wherein the mixing rod extends away from the inner surface and inside the pitcher body.

2. The pitcher assembly of claim 1 further comprising:
a clutch housing connected with the lid; and
a clutch body rotatably engaged with the clutch housing and connected with the mixing rod.

3. The pitcher assembly of claim 2, wherein the clutch body is integrally formed as one piece with the mixing rod.

4. The pitcher assembly of claim 2, wherein the lid assembly further comprises a threaded rod fixedly connected with the plunger, wherein the threaded rod is received by a slot opening in the clutch body and upon pressing the plunger downward toward the outer surface of the lid, the threaded rod rotates the clutch body and the mixing rod.

5. The pitcher assembly of claim 2, wherein the lid assembly further comprises a spring positioned inside the plunger between the plunger and the outer surface of the lid, wherein the spring urges the plunger back to a resting position away from the outer surface of the lid.

6. The pitcher assembly of claim 1, wherein the mixing rod includes a lower apex which cooperates with a depression in a bottom of the pitcher body, providing a point of rotation for the mixing rod.

7. A container for holding liquid comprising:
a housing forming an opening along a top edge of the housing; and
a lid assembly mounted to the housing and covering the opening, the lid assembly comprising:
a lid having an outer surface and an inner surface,
an engagement member movably connected with and extending from the outer surface of the lid, and
a mixing rod movably connected with the engagement member and extending inside the housing.

8. The container for holding liquid of claim 7, wherein the lid assembly further comprises a clutch housing connected with the lid, and a clutch body rotatably engaged with the clutch housing and fixedly connected with the mixing rod.

9. The container for holding liquid of claim 8, wherein the clutch body is integrally formed as one piece with the mixing rod.

10. The container for holding liquid of claim 8, wherein the lid assembly further comprises a projecting member fixedly connected with the engagement member, wherein the projecting member is received by an opening in the clutch body, and wherein upon activating the engagement member, the projecting member moves through the opening in the clutch body, causing the clutch body to rotate.

11. The container for holding liquid of claim 8, wherein the lid assembly further comprises a biasing member connected with the engagement member which biases the engagement member in a resting position.

12. The container for holding liquid of claim 7, wherein the engagement member is movable between a resting position, in which the mixing rod is stationary, and a depressed position, in which the mixing rod is rotated.

13. A container for holding liquid comprising:
a housing forming an opening along a top edge of the housing; and
a lid assembly mounted to the housing and covering the opening, the lid assembly comprising:
a lid,
an engagement member connected with the lid, and
a mixing rod connected with the engagement member and extending inside the housing, wherein the mixing rod is rotated upon activation of the engagement member.

14. The container of claim 13, wherein the lid assembly further comprises a rotational member connected with the engagement member and with the mixing rod, wherein the rotational member rotates upon activation of the engagement member to rotate the mixing rod.

15. The container of claim 13, wherein the lid assembly further comprises a clutch housing connected with the lid, and a clutch body rotatably engaged with the clutch housing and fixedly connected with the mixing rod.

16. The container of claim 15, wherein the clutch body is integrally formed as one piece with the mixing rod.

17. The container of claim 15, wherein the lid assembly further comprises a projecting member fixedly connected with the engagement member, wherein the projecting member is received by an opening in the clutch body, and wherein upon activating the engagement member, the projecting member moves through the opening in the clutch body, causing the clutch body to rotate.

18. The container of claim 15, wherein the lid assembly further comprises a biasing member connected with the engagement member which biases the engagement member in a resting position.

19. The container of claim 13, wherein the mixing rod includes a lower apex which cooperates with a depression in a bottom of the housing, providing a point of rotation for the mixing rod.

20. The container of claim 13, wherein the mixing rod includes a mixing leaf.
